(19) United States
(12) Patent Application Publication
(10) Pub. No.: US 2009/0286027 A1
(43) Pub. Date: Nov. 19, 2009

(54) METHOD FOR MANUFACTURING A BLOW MOULDED PART AND BLOW MOULDED PART

(76) Inventor: Derk Fleischmann, Steinhagen (DE)

Correspondence Address: SCHMEISER, OLSEN & WATTS, 22 CENTURY HILL DRIVE, SUITE 302, LATHAM, NY, 12110, US

(21) Appl. No.: 12/466,633

(22) Filed: May 15, 2009

(30) Foreign Application Priority Data
May 16, 2008 (DE) 102008024024.9

(51) Int. Cl. B32B 3/06; B29C 45/14

(52) U.S. Cl. 428/35.7; 264/500

(57) ABSTRACT

The invention concerns a method for manufacturing a blow moulded part with fixing elements, particularly an automotive equipment part, in which a body of the part is formed in a tool using blow moulding of a plastic blank, wherein an enclosed section of a fixing component for forming the fixing elements using blow moulding is entirely surrounded and enclosed by an outer surface of the plastic blank and a mounting section of the fixing component is formed unenclosed by and free of contact with the plastic blank. Further, the invention concerns a blow moulded part with fixing elements, particularly an equipment part.

The invention relates to a method for manufacturing a blow moulded part with fixing elements, particularly an automotive equipment part, as well as a blow moulded part with fixing elements.

### BACKGROUND OF THE INVENTION

Extrusion blow moulding serves in the production of blow moulded parts. For this case, normally a plastic blank, preferably a plastic tube, is inserted into an opened moulding tool. The moulding tool is then closed and the plastic inflated with pressurized air so that the plasticized (hot) synthetic material is pressed against the contour of the interior of the moulding tool to thus form a plastic part, which is often water-cooled and can be removed from the moulding tool after a cooling period. While component injection moulding is primarily used for producing solid parts, blow moulding technology mainly produces hollow objects.

A blow moulded part is known from the document DE 40 36 462 C2 in the form of a seat-frame construction for a vehicle seat. Fixing elements, which can be used to mount the seat frame after it has been manufactured, are integrated one-sidedly as well as enclosingly on the end portions into a wall of a blow moulded hollow plastic body.

For example, load platforms for automobiles are known from prior art, in which stabilizing braces are inserted in an additional assembly step for stabilizing as well as for attaching the platform.

A method for producing a seat and seats is known from the document DE 691 11 454 T2 where a reinforcement frame, which is constructed of one piece, is partially embedded into a plastic part using blow moulding. Underneath the seat's surface and built into the reinforcement frame is a connection or mounting piece, which is likewise enclosed on one side by the plastic part. As with the reinforcement frames for the seat, it is also known for containers to provide reinforcing elements in wall sections of a plastic container with the reinforcing elements being integrated flatly into the plastic wall (see DE 42 21 766 B4).

A blow mould method is known from the document JP 0347728 for producing a blow mould body with fully-integrated reinforcement.

### SUMMARY OF THE INVENTION

The object of the invention is to create an improved method for producing a blow moulded part with fixing elements as well as a blow moulded part where the attachment and mounting possibilities for the blow moulded part are optimized.

This object is achieved according to the invention by using a method for producing a blow moulded part with fixing element according to the independent claim 1 as well as a blow moulded part with fixing element according to the independent claim 4. Advantageous embodiments of the invention are the subject of dependent sub-claims.

The invention comprises the idea of creating an enclosed section of a fixing component as well as a mounting section of the fixing component for forming the fixing elements using blow moulding in a blow moulded part with fixing elements, particularly an automotive equipment part like an automotive seat shell, wherein the enclosed section is entirely surrounded and enclosed by an outer surface of the plastic blank and the mounting section is formed unenclosed and free of contact with the plastic blank.

Thus, on the one hand, a sufficient fixation of the fixing elements in the form of the fixing component at the body of the part is guaranteed as the enclosed section is completely enclosed. In doing so, the outer surface of the plastic blank surrounds the associated section of the fixing component during blow moulding. The areas surrounding the associated section of the plastic blank are then melted together with one another during contact, so that a complete enclosure is created. On the other hand, the possibilities for mounting the blow moulded part are optimized in that the mounting section of the fixing component is completely free from the plastic processed by blow moulding. There are no limitations, such as those of the prior art, where fixing components are covered in partial areas by the plastic. By means of the invention, an optimized application of both functions, sufficient holding on the body of the plastic part on the one hand, and the most flexible possible mounting for the blow moulded part with the fixing elements on the other hand is achieved.

A purposeful embodiment of the invention provides that the mounting section is formed projecting from the body of the part.

An advantageous additional development of the invention can provide that the fixing component is made from a profile component. Preferably, a hollow profile can be utilized. But, a solid material can also be employed. To optimize the fixation of the enclosed section of the fixing component in the plastic enclosure, the component section can be designed with a non-rounded cross section, for example an elliptical cross section or a rectangular or triangular cross section. Due to the tight enclosure of the enclosed section of the fixing component in the plastic body, contortion of the fixing component is prevented.

An embodiment of the invention can provide that the fixing component is made as a rod-shaped part.

### DESCRIPTION OF PREFERRED EXEMPLARY EMBODIMENTS OF THE INVENTION

The invention will be more closely explained below with realizations in reference to figures in a drawing. Here show:

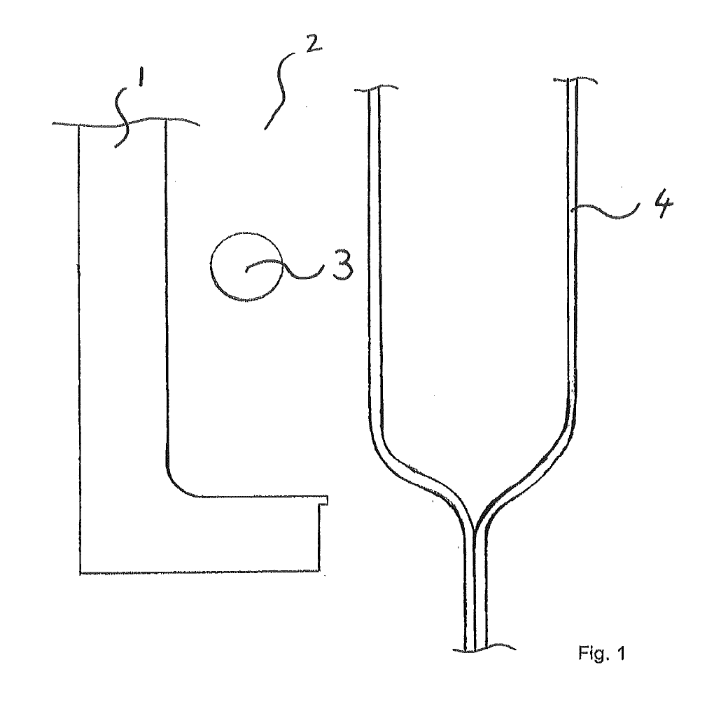

FIG. 1 a schematic illustration of a section of a blow moulding tool with an associated plastic blank before the blowing process,

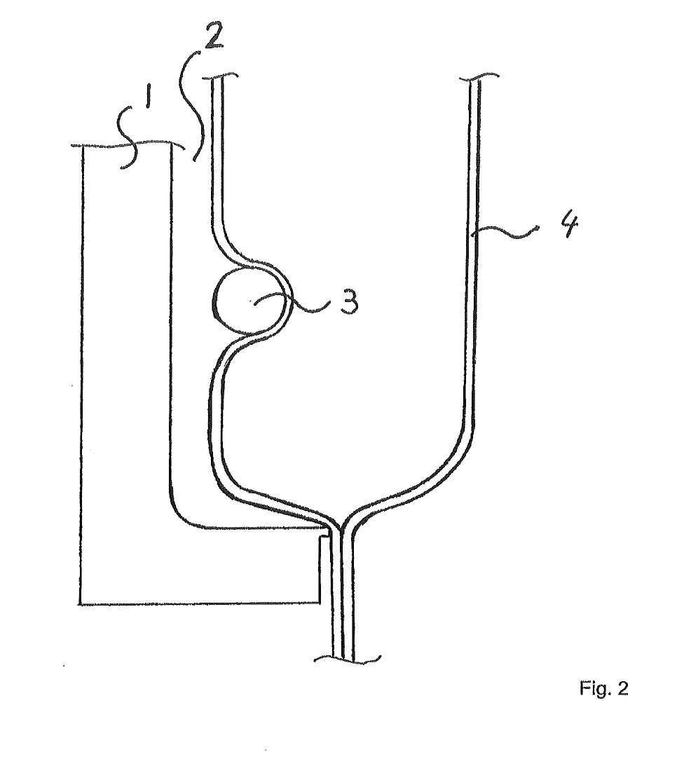

FIG. 2 a schematic illustration of the section of the blow moulding tool of FIG. 1, with the blowing process having begun, and

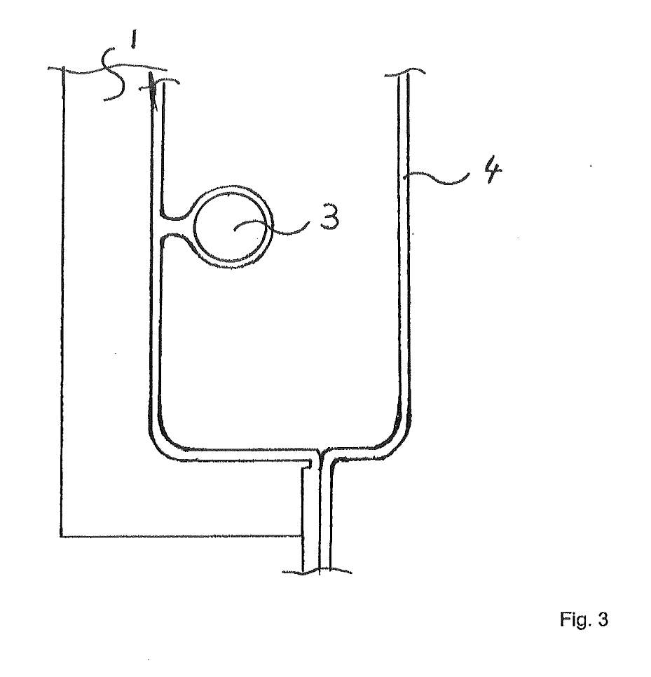

FIG. 3 a schematic illustration of the section of the blow moulding tool of FIG. 1 at the end of the blowing process, a section of the fixing component being entirely enclosed by the plastic blank.

FIG. 1 shows a schematic illustration of a section of a blow moulding tool 1, in whose interior 2 an fixing component 3 is attached in such a way that it extends into the interior 2. In FIG. 1 a plastic blank 4 is furthermore illustrated in the form of a heated plastic tube.

FIG. 2 shows a schematic illustration of the section of the blow moulding tool of FIG. 1, with the blowing process having begun.

FIG. 3 shows a schematic illustration of the section of the blow moulding tool 1 at the end of the blowing process, the fixing component 3 in the area of the illustrated section being entirely enclosed by the plastic blank 4.

On the blow moulding tool, sliders (not illustrated) are provided to enable the insertion of the fixing component 3.

The blow moulding of the plastic blank 4 takes place in the usual manner in that the plastic blank 4 is extruded and stretched over expanding mandrels (not depicted). Welding is to be done using a staple-plate (not illustrated). The utilization of support air results in a form-stable plastic blank 4. During closing the blow moulding tool 1, the plastic blank 4 lies against the inner walls of the blow moulding tool 1. In so doing, it then lays against the enclosed section of the fixing component 3 and embeds this. To achieve a consistent wall thickness distribution around the enclosed section, an outer surface coating on the enclosed section of the fixing component 3, for example, can be provided, which results in a better binding with the plastic blank 4. The binding of the fixing component 3 is positively influenced by using a suitable cross section design. After the blow moulding process, the tool opens, the sliders go to the side and release the produced plastic body.

The features of the invention disclosed in the preceding description, the claims and the figures can be of importance in the realization of the invention individually as well as in any desired combination of their various exemplary embodiments.

1. A method for manufacturing a blow moulded part with fixing elements, particularly an automotive equipment part, in which the body of the part is formed in a tool by blow moulding a plastic blank, wherein for forming the fixing elements an enclosed section of a fixing component is entirely surrounded and enclosed by an outer surface of the plastic blank and a mounting section of the fixing component is formed unenclosed and free of contact with the plastic blank.

2. The method according to claim 1, characterized in that the mounting section is formed projecting from the body of the part.

3. The method according to claim 1, characterized in that the fixing component is formed from a profile component.

4. A blow moulded part with a fixing element, particularly an automotive equipment part, with the body of the part formed using the blow moulding of a plastic blank, the fixing elements being formed by an enclosed section of a fixing component which is entirely surrounded and enclosed by an outer surface of the plastic blank and a mounting section of the fixing component which is made unenclosed by and free of contact with the plastic blank.

5. The part according to claim 4, characterized in that the mounting section is formed projecting from the wall of the part.

6. The part according to claim 3, characterized in that the fixing component is formed from a profile component.
